(19) United States
(12) Patent Application Publication
(10) Pub. No.: US 2024/0103970 A1
(43) Pub. Date: Mar. 28, 2024

(54) BACKUP IMAGES FOR COMPUTING DEVICES

(71) Applicant: Hewlett-Packard Development Company, L.P., Spring, TX (US)

(72) Inventors: Gaetan Wattiau, Bristol (GB); Adrian John Baldwin, Bristol (GB); Stuart Lees, Bristol (GB)

(21) Appl. No.: 17/934,812

(22) Filed: Sep. 23, 2022

(51) Int. Cl. G06F 11/14; G06F 9/4401

(52) U.S. Cl. CPC G06F 11/1417; G06F 9/4403; G06F 9/4406; G06F 2201/805

(57) ABSTRACT

In an example, a computing device includes a processor which in a reimaging operation of the computing device, may determine if a backup image to be used in the reimaging operation is available from a memory device connected to a local area network of the computing device. When the backup image is available from the memory device, the processor may acquire the backup image over the local area network. When the backup image is not available from the memory device, the processor may determine if a backup image is available from a wide area network of the computing device.

### BACKGROUND

A computing device can undergo an ‘imaging’ process, in which software, such as operating systems (OS) and in some examples other programs or applications, are installed. In some examples, a computing device may be reimaged, in which case an OS may be reinstalled. In some examples, such processes utilize a basic input/output system (BIOS) during a boot process of the computing device.

### BRIEF DESCRIPTION OF DRAWINGS

Non-limiting examples are described with reference to the accompanying drawings, in which:

FIG. 1 is a simplified schematic drawing of an example computing device connected to a local area network and a wide area network;

FIG. 2 is a simplified schematic drawing of an example method for acquiring a backup image;

FIG. 3 is a simplified schematic drawing of an example set of data exchanges in a method of acquiring a backup image;

FIG. 4 is a simplified schematic drawing of an example method of a memory device acquiring a backup image;

FIG. 5 is a simplified schematic drawing of another example method of acquiring a backup image;

FIG. 6 is a simplified schematic drawing of an example computing device;

FIG. 7 is a simplified schematic drawing of another example computing device; and

FIG. 8 is an example machine readable medium in association with a processor.

### DETAILED DESCRIPTION

A user may utilize a computing device for various purposes, such as for business or recreational use. As used herein, the term “computing device” refers to an electronic system having any or any combination of a processing resource, memory resource, and an application-specific integrated circuit (ASIC) that can process information. A computing device can be, for example, any or any combination of a laptop computer, a notebook computer, a desktop computer, a tablet, and a mobile device, among other types of computing devices.

On occasion, for example as a result of malware, disk corruption or device management, reimaging of a computing device may occur. During such a process, an image (referred to herein as a backup image) may be obtained. An image in this context is data providing software. In some examples, this may be data providing an operating system (OS), usually in some default state. For example, the image may provide a computing device with an initial ‘out of the box’ state, i.e. the same state that a user would experience when switching on the computing device for the first time. However, images may also include any or all of user customisations, enterprise customisations, applications, or the like. Reimaging may be used to update a computing device, for example to provide patches or updates for software deployed thereon. In the case that a computing device is to be re-initialised, it may be reimaged with an up-to-date image, as opposed to the original image installed when the computing device was first initialised. In other examples, a backup image may comprise a recovery agent image, which may be used to aid in recovery processes, which may include the process of installing an OS image.

Reimaging a computing device may be performed by a basic input/output system of a computing device. As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of a computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In some examples, backup images may be stored remotely from a computing device at a server accessible via a wide area network such as the internet. In other examples, an image may be stored on a removable media (e.g. a machine readable media which may comprise Read Only Memory (ROM) such as a CD ROM). In other examples, the computing device may store a local image for example in its memory, which may be in a dedicated memory such as a MultiMedia Card (MMC), which may be an Embedded MultiMedia Card (eMMC).

In the first case, when backup images are stored at a remote server and in particular if a number of computing devices in a local area are to be reimaged, this can result in high network traffic between the computing device and the server, in turn meaning that the process of recovery or updating can be slow, or other network traffic may be disrupted. In the case where the computing device stores an image in memory thereof, stored images may be periodically updated, which can again result in high network traffic. Moreover, use of removeable media for providing a backup image is cumbersome.

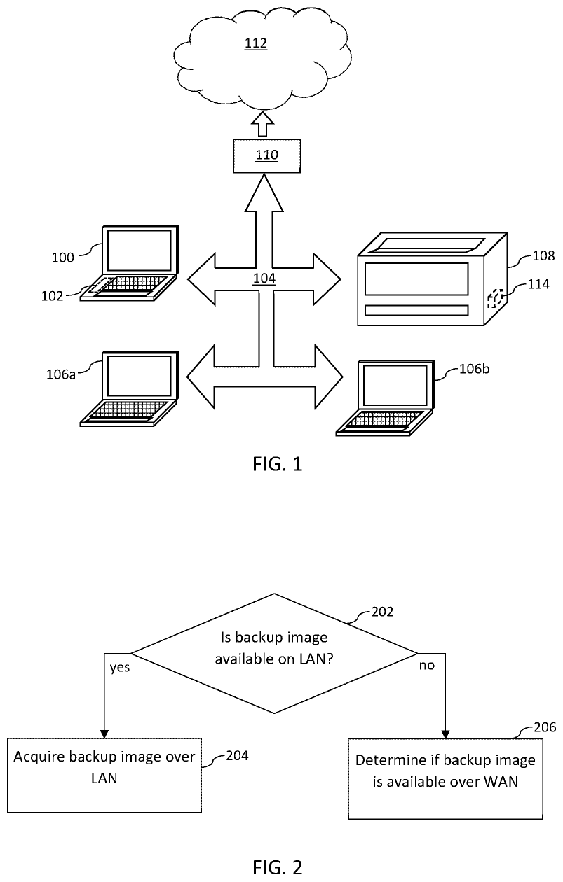

FIG. 1 shows an example computing device 100 comprising a processor 102. The computing device 100 is connected to a local area network (LAN) 104. An example LAN may connect devices within a local area such as an office building, residence, school, laboratory, etc. The LAN may be a wired LAN or a wireless LAN, for example using WIFI or the like. In some examples, the LAN 104 may be under the control of an entity such as a business enterprise, a house holder or the like.

In this example, there are a plurality of other devices connected to the LAN 104, in particular two further computing devices 106a, 106b, a print apparatus 108 and a router 110 which provides access to a Wide Area Network (WAN) 112, in this example the internet. However, in other examples the LAN 104 may comprise any number of different entities including other computing devices, or devices which provide services such as printing, scanning, sensor apparatus or the like. Moreover, in some examples, the computing device 100 may connect to the WAN 112 directly rather than through an external router 110.

In this example the print apparatus 108 comprises a memory device 114. In other examples, a memory device 114 may be provided within another ‘host’ device connected to the LAN 104 and therefore the print apparatus 108 provides an example of a host device. In other examples, a memory device 114 may be provided as a stand-alone memory device.

In some examples, a system may comprise at least the computing device 100, the LAN 104 and the memory device 114. In some examples, the system may further comprise at least one host device in which the memory device 114, or another memory device, is provided.

FIG. 2 is an example of a process which may be carried out by the processor 102 in a reimaging operation of the computing device 100. This may for example form part of a recovery operation, or routine maintenance of the computing device 100. For example, this may be prompted by a user on finding that their computing device 100 is non-operational (e.g. failing to boot as expected), in response to an updated image being available, when a report of malware is received, when the device is not operating as expected (e.g. frequently crashing or applications running thereon are regularly failing), or the like. In other examples, this may be prompted by a device manager, which may be an application stored on the computing device 100, or may be connected to the computing device over a network (e.g. the LAN 104, the WAN 112, or some other network).

In block 202, the processor 102 determines if a backup image to be used in the reimaging operation is available from the memory device 114 connected to the LAN 104 of the computing device 100 (i.e., the LAN 104 to which the computing device is connected).

For example, this may comprise broadcasting, by the computing device 100 or the processor 102 thereof, a request for the backup image on the LAN 104. For example, this may be broadcast using a protocol such as service location protocol (SLP) or mDNS (Bonjour).

In other examples, the computing device 100 may comprise a non-volatile memory storing data indicative of at least one possible location of a backup image available from a memory device connected to the LAN 104. For example, this may comprise an IP address or the like. In such examples, determining if the backup image to be used in the reimaging operation is available from a memory device connected to the LAN 104 may comprise transmitting the request to such a location, e.g. to a LAN address, stored in the non-volatile memory. Therefore, considering the example network of FIG. 1, this may comprise sending the request to the LAN address of the print apparatus 108. More generally, the request may be sent to the memory device 114 or to a host device in which the memory device 114 is provided. After transmitting the request, the processor 102 of the computing device 100 may wait for a response, for example until a specified amount of time passes.

For example, a backup image may be deemed to be available from the memory device 114 in block 202 when the memory device 114 stores a backup image, or when the memory device 114 stores a backup image meeting established criterion, or when the memory device 114 is able to acquire the backup image. In some examples, if the memory device 114 receives a request for an image which it cannot provide from its own memory, the memory device 114 may be configured or managed to download an image over the WAN 112, in order to provide the image to the requesting computing device 100 or in anticipation of further requests from other devices on the LAN 104. Moreover, if the image held by the memory device 114 is out of date, this may be updated on the memory device with a patch or the like received over the WAN 112 in response to the request from the computing device 100.

When the backup image is available from the memory device 114, whether as a result of having been stored thereon before a request from the computing device 100 is received, or as a result of being acquired or updated following a request from the computing device 100, and, in some examples, when at least one of the backup image and the memory device 114 are successfully validated, the processor 102 proceeds to block 204, and acquires the backup image over the LAN 104.

However, in some examples, it may be deemed that the backup image is not available from the memory device 114 in block 202. For example, this may be the case if the processor 102 has waited for more than a specified time since making a request without receiving a reply, the memory device 114 has indicated that it does not store or cannot access a backup image, or it has been determined that a backup image available from the memory device 114 is not to be used, for example because it is outdated or not suited to the computing device 100. In such examples, the processor 102 proceeds to block 206, in which the processor 102 determines if a backup image is available on the WAN 112 to which the computing device 100 is connected.

By including a stage in the reimaging process that looks for sources of backup images on the LAN 104, a memory device 114 on (i.e. connected to) the LAN 104 may provide a backup image distribution point, thus saving network traffic over the WAN 112. If however an image is not available from the memory device 114 on the LAN 104, then the processor 102 may seek the backup image from a remote server or the like over the WAN 112.

In some examples, the memory device 114 may comprise a device on the LAN 104 which has an identity, some memory and some computing capability, or may be hosted by a host device having such capability. The memory device 114 may form part of a device which is at least one of a managed LAN device and trusted in LAN operations. For example, the memory device 114 or a host apparatus thereof may be configured or managed so as to check or poll a remote server to determine if there is an available new backup image, or an available update to a backup image. Such an image may in some examples be downloaded at a convenient time, for example overnight when the WAN 112 may be less active. The memory device 114 or a host apparatus thereof may be provided with suitable digital certificates or the like to allow it to access such data.

In the example of FIG. 1, the memory device 114 is provided as part of a host device comprising a print apparatus 108. Print apparatus 108 are often provided with a relatively substantial memory storage capacity, and thus may have spare capacity, and have some computing capability. Moreover, such apparatus may be trusted, have an established identity on the LAN 104 and thus may be readily utilised in this manner. Such devices are often managed by an enterprise which also manages other computing devices connected to a LAN. However, in principle, other examples of devices which could comprise or host the memory device 114 include any device which provides another service on the LAN 104, for example an edge computing device (e.g. a device providing some memory and compute power at the edge of the LAN 104 so as to be close to a data source), a file server, Network Attached Storage (NAS) systems, a local memory device with compute capability, an IOT device having a memory and some compute capability or the like. In summary then, devices with a function on the LAN 104, such as providing printing, scanning or sensor services, may, as a further function, host a memory device 114 which can provide backup images, and may for example execute recovery management code. In other examples, a dedicated memory device 114 to store at least one backup image may be provided on the LAN 104.

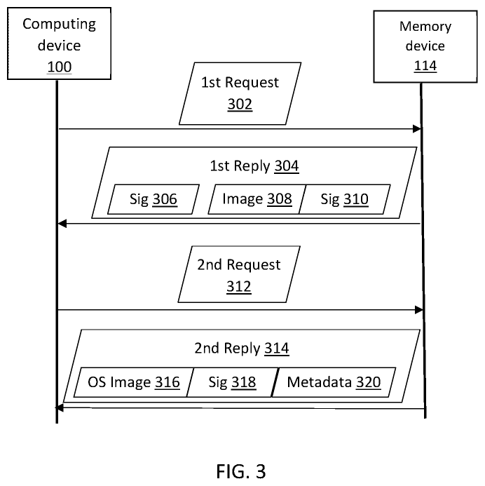

FIG. 3 shows an example of data exchanges which may be carried out in the execution of blocks 202 and 204 of FIG. 2, in which the processor 102 determines if a backup image to be used in the reimaging operation is available from the memory device 114 connected to the LAN 104 to which the computing device 100 is also connected, and acquires an image over the LAN 104 if available.

In this example, a request for a backup image (first request 302) is sent from the computing device 100 and via the LAN 104 to the memory device 114. As mentioned above, this may for example be sent to the address of the memory device 114, or may be broadcast on the LAN 104. If the first request 302 is sent to a specific address, this may be an address held in non-volatile memory of the computing device 100, which may for example be associated with at least one of an embedded security controller and a BIOS of the computing device 100.

In some examples, the first request 302 may include an ID for the computing device 100 so that the memory device 114 (or associated processing circuitry which may be a processor of a host apparatus thereof) can determine if a backup image it holds is suitable for that computing device 100. In some examples, the first request 302 may include a specification of at least one criteria such as an acceptable image size, or at least one image version. Such a specified image version may be or include an older version than the most up-to-date version, but may be acceptable in order to expedite recovery of the computing device 100 to provide a working system. In some examples, the acceptability of an outdated version may depend on the nature of any more recent updates, such as whether they patch critical security issues. In some such cases, use of an older image may be prevented. Moreover, it may be intended that the image received is suitable for the given computing device hardware, for example to avoid supply of images with non-functioning or non-optimal drivers for the computing device 100.

In some examples, instead of or in addition to receiving data indicating an acceptable image from the computing device 100, the memory device 114 (or associated processing circuitry) may verify that its image is suitable for the computing device 100 by sending a query to a remote image server. For example, this may verify that an image held is sufficiently up-to-date to be sent to the computing device 100, or is suited to the hardware of the computing device 100, or the like.

Assuming that the memory device 114 purports to hold a valid copy of the backup image, a first reply 304 is sent from the memory device 114 (or associated processing circuitry which may be a processor of a host apparatus thereof) to the computing device 100 over the LAN 104. In this example, the first reply 304 comprises a device signature 306 for the memory device 114 and a backup image, in this example a recovery agent image 308 having a digital signature 310.

In some examples, if the memory device 114 does not hold a copy of the backup image which is suitable, then a reply may instead indicate that no backup image is available from that memory device 114.

In other examples in which the memory device 114 does not hold a copy of the backup image which is suitable, the memory device 114 (or associated processing circuitry) may request a copy of an image, or an update to its stored image, if outdated, via the WAN 112 to send to the computing device 100, or in anticipation of further requests. For example, the memory device 114 may be an established image storage device for a remote image server, and thus mutual authentication between the memory device 114 and such an image server may in some examples be relatively efficient, and may be more efficient than a validation between the computing device 100 and the remote image server. Thus, it may be more efficient over all for the memory device 114 to acquire and forward the image than for the computing device 100 to acquire the image over the WAN 112 from the remote image server.

In some such examples, the computing device 100 may await the backup image and, once it is available at the memory device 114, the first reply 304 may be sent as described above. In some such examples, the memory device 114 (or associated processing circuitry) may send a reply to the computing device 100 over the LAN 104, indicating that a copy of the backup image is being accessed and may be available soon. In some such examples, a new image or image update may be streamed to the memory device 114 over the WAN 112 and received portions of the image may be sent on to the computing device 100, for example streamed, over the LAN while other portions are still being downloaded over the WAN 112. This may reduce delays in waiting for a new image to be delivered to the computing device 100.

Assuming the first reply 304 has been sent, the computing device 100 then checks the signatures 306, 310, for example using at least one cryptographic key stored on non-volatile memory of the computing device 100, or in some other manner.

For example, the memory device 114, or associated processing circuitry such as a processor of a host apparatus on which the memory device 114 is provided, e.g. the print apparatus 108 in the example of FIG. 1, may have both a device identity demonstrating it is a particular type or brand of printer and an enterprise certificate. The enterprise certificate may be used to ensure that the memory device 114 stores authorized versions of a backup image, and that valid backup images are not supplied to an unauthorized memory device 114. In some examples, the enterprise certificate allows parties to trust each other in transaction(s) via client and server certificate authentication. For example, the computing device 100 and the memory device 114 (or associated memory device of host apparatus thereof) may each hold a certificate signed by an enterprise root Certificate Authority (CA). This allows the computing device 100 and memory device 114 to trust each other, since both certificates are signed by the same root CA. Moreover, at least one of the computing device 100 and memory device 114 (or associated processing circuitry such as a processor of host apparatus thereof) may validate a management system which provides images thereto over the WAN 112. In some examples, the identity of the memory device 114 or its host apparatus may be checked, for example by the processor 102 of the computing device 100, or another entity which may be an entity on the LAN 104, to ensure it is validly part of the LAN 104. In some examples, the validation may comprise validating that the memory device 114 is managed by an enterprise that manages the computing device 100. In some examples, the validation may comprise checking one or more properties of the memory device 114 or the host apparatus to ensure they match saved properties (for example, the software version or the like). This may provide additional protection against any or any combination of replay attacks and malware attacks. In general, the computing device 100 may seek to ascertain that the memory device 114 is any or any combination of legitimate (for example having installed enterprise certificates or the like), is in an expected state, or is unlikely to have been compromised by malware or an attacker who may have interest in delivering a malicious or corrupted image to the computing device 100.

Assuming that the signatures are valid, the recovery agent image 308 may be stored in a memory of the computing device 100, for example in a Random Access Memory (RAM), and may be booted therefrom.

In some examples, a signature may be provided separately from the image 308 (although it may contain a reference to an identifier for the image, or the like), such that the computing device 100 may not accept the backup image if it is not signed by an established authority. However, if the signature is validated, then the computing device 100 may assume that the image is provided by an authorized source prior to initiating download of the image 308.

In this example, the recovery agent image 308 includes a location (e.g. at least one IP address) of a ‘full’ OS backup image and may contain additional information to assist in subsequent operations in the recovery process. For example, it may provide instructions for establishing a recovery environment. A recovery environment may be able to repair some issues, cause the computing device to operate in a safe mode or the like. In some examples, the recovery agent may carry out at least one of formatting or partitioning a memory (e.g. a non-volatile disk) such that it is ready to receive a new OS image. One example of a recovery agent image is an image that may launch WinRE in the Windows Operating System.

In some examples, the recovery agent image 308 indicates more than one potential location for the OS backup image. For example, within an enterprise subnet LAN, information could be used to derive locations and find associated memory devices which may store backup images, or portions thereof. For example, this may allow the computing device 100 to identify a suitable location or locations in which the image is stored. For example, the processor 102 of the computing device 100 may execute instructions to identify at least one suitable memory device of a plurality of candidate memory devices to supply the image based on any or any combination of: the distance to a candidate memory device (with a lower distance being favoured), the bandwidth between the computing device and a candidate memory device (with a higher bandwidth being favoured), CPU load of a candidate memory device (with a lower load being favoured), number of clients of a candidate memory device (with fewer clients being favoured), how up to date an image held on a candidate memory device is (with more up to date images being favoured), or the like. In some examples, different portions of the image may be acquired from different memory devices. While a plurality of candidate locations are described herein for the OS backup image, there may similarly be a plurality of candidate locations for the recovery agent image 308, for example indicated in a non-volatile memory of the computing device 100, or discoverable on the LAN.

In this example, the recovery agent image 308 provides the location of the OS backup image. The OS backup image may provide data to install an OS in the computing device. In this example, the recovery agent image 308 indicates that the location of the OS backup image is also on the memory device 114. In some examples however, the OS backup image may be provided by the WAN 112. In such cases, the LAN 104 and the computing device 100 benefit from at least the recovery agent image 308 being provided locally, as it avoids passing data associated with provision of the recovery agent image over the WAN 112, and thereby potentially contributing to high network traffic on the WAN 112. In further examples, the OS backup image may be provided from a different device or devices on the LAN to the recovery agent image 308.

Therefore, the computing device 100, after accessing the location for the OS backup image in the recovery agent image 308, sends a second request 312 to the memory device 114, wherein the second request 312 is a request for the OS backup image. In some examples, the second request 312 may include at least one of an ID for the computing device 100 and criteria or criterion as set out above so that the memory device 114 (or another device receiving the request) may determine if a backup image it holds is suited to that computing device 100.

Assuming that the memory device 114 purports to hold a suitable OS backup image, it (or associated processing circuitry) responds with a second reply 314 comprising the backup image 316, signed using a digital signature 318, and metadata 320 describing the backup image 316. In some examples, if the memory device 114 does not hold a copy of the backup image which is suitable, then a reply may instead indicate that no backup image is available from the memory device 114. In some examples, if no suitable image is found, the memory device 114 (or associated processing circuitry) may request a copy of the image, or an update to its stored image, if outdated, via the WAN 112 in anticipation of further requests or to provide to the computing device 100. As described above, the computing device 100 may wait for such an image to become available, in which case there may be a delay before the second reply 314 is sent. As mentioned above, any delay may be minimised in some examples by sending a first part of an image while a second part of the image is still being received (e.g. streamed) over the WAN 112.

The computing device 100 may validate the backup image 316, for example by the processor 102 using at least one cryptographic key to validate the signature 318. Moreover, the computing device 100, or the processor 102 thereof, reads the metadata 320 to verify that the backup image 316 is to be installed. For example, this may comprise verifying that the backup image 316 is not outdated, for example having a version which corresponds to a version of the OS which was previously installed in the computing device 100 (which may for example be stored in a memory, for example a non-volatile memory, thereof). While in this example, the memory device 114 may be considered to have been already validated, in other examples, the memory device 114 (or other source of the image) may be validated at this stage.

The OS may then be installed on the computing device 100 from the image.

In some examples, there may be more than one image available from the memory device 114 which could be included in at least one of the first reply 304 and second reply 314. In some such examples, an image may be selected from the available images by a user of the computing device 100 or automatically, for example, based on metadata. For example, different images may have different applications installed. While offering a choice of images over the WAN 112 may be inefficient, this may become practical when providing images over the LAN 104. Moreover, some users may modify their computing device 100 (for example providing or reducing resources such as RAM, hard disks, graphics cards, and the like), so the computing device 100 may seek to ascertain that the supplied image would be suitable for such modifications. In some examples, the selection may be made based on any or any combination of the brand, type or model of the computing device 100, any modification made thereto, or the like.

Thus, in this example, a backup image (for example, at least one of the recovery agent image or the OS backup image) may be provided over the LAN 104. As noted above, if a backup image (for example, either or both of the recovery agent image or the OS backup image) is not available from the memory device 114 on the LAN 104, then the computing device 100 may seek a backup image over the WAN 112 as described above with reference to block 206.

In this example, both backup images (the recovery agent image and the OS backup image) were acquired completely from a single memory device 114. However, in other examples, at least part of at least one backup image may be acquired from a second memory device, which may be provided on the LAN 104 or via the WAN 112. Requesting different parts of a backup image from different memory devices 114 may speed up the recovery process, in particular if all the sources of the different parts are provided on the LAN 104.

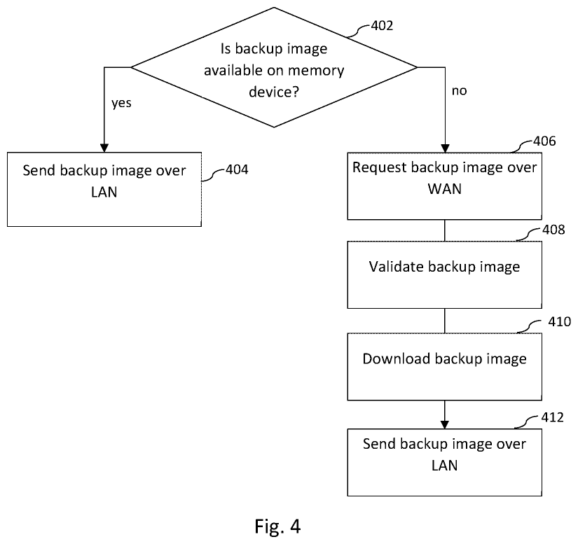

FIG. 4 is an example of a method of providing a backup image in the event that a backup image (or a backup image meeting any specification(s) provided by the computing device 100 or a user thereof) is not available from the memory device 114. For example, this may be because the memory device 114 does not hold an image, an image is held but is not suited to the computing device 100, an image is held but is out of date, or for some other reason.

In block 402, the memory device 114 (or associated processing circuitry) determines if a (suitable) image is available. If so, it is provided over the LAN in block 404, for example as described above. When it is determined that the image is not available, the memory device 114 (or associated processing circuitry) requests the image over the WAN in block 406. A validation process may be carried out before the image is downloaded. In this example, at least one of a server providing the image may be validated and any signature of the image may be validated by the memory device 114 (block 408), or by associated processing circuitry. Assuming that the validation is successful, the backup image is downloaded in block 410. This image may then be provided to the computing device 100 over the LAN in block 412, for example as part of the first reply 304 or second reply 314 described above. As noted above, in some examples, when acquiring a backup image in this way, the memory device 114 may send a reply to the computing device 100 indicating that a new image is being acquired. In some examples, the absence of a (suitable) backup image may serve as a prompt to the memory device 114 to update itself, whether or not the image is sent on to the computing device 100 from which the request originated. Moreover, in some examples, block 410 and 412 may be carried out at least partially concurrently, for example by streaming part of the backup image to the computing device 100 over the LAN 104 while part thereof is yet to be received over the WAN 112.

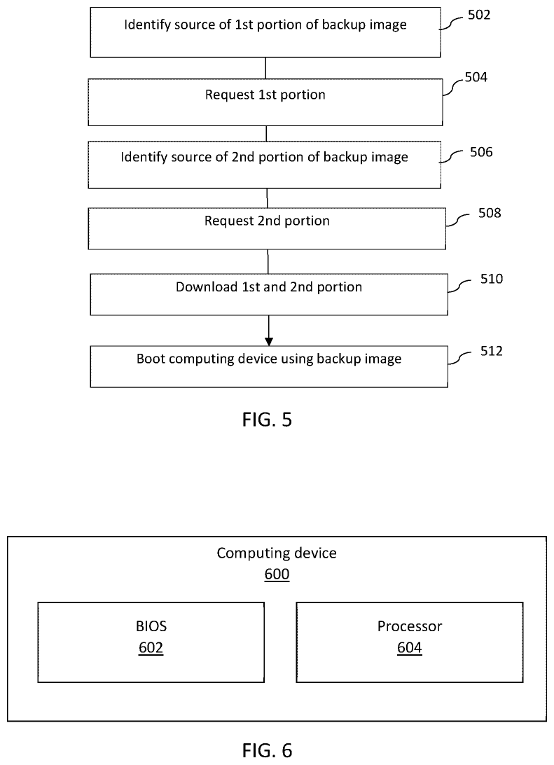

FIG. 5 is an example of a method of acquiring a backup image from a plurality of different memory devices. For example, this may allow a backup image to be installed more quickly as it may distribute the use of resources.

In this example, block 502 comprises identifying, by the computing device 100 or the processor 102 thereof, a source of a first portion of a backup image from a first memory device. In one example, the backup image comprises an operating system image. Block 504 comprises requesting, by the computing device 100 or the processor 102 thereof, the first portion of the backup image from the first memory device. Block 506 comprises identifying, by the computing device 100, a source of a second portion of a backup image from a second memory device. Block 508 comprises requesting, by the computing device 100 or the processor 102 thereof, the second portion of the backup image from the second memory device. For example, the sources may be specified in a non-volatile memory of the computing device, or provided with a recovery agent image, or provided in some other way. For example, the requests of block 504 may comprise requests as described in relation to FIG. 3. In some examples, both the first and second memory devices may be connected to the same LAN as the computing device is connected to, although in other examples, a first memory device is connected to the LAN while at least one other memory device is not on the same LAN, or is connected to the computing device 100 via a WAN.

Block 510 comprises downloading, by the computing device 100 or the processor 102 thereof, the first and second portions of the backup image from the first and second memory devices. Block 512 comprises booting the computing device 100 using the backup image. In some examples, each portion of the backup image may be validated as described above, for example prior to being downloaded. In some examples, each memory device which provides a source of a backup image portion may be validated as described above. Moreover, the image may comprise a recovery agent image rather than a full operating system image.

While two memory devices were described in this example, in other examples, there may be more memory devices storing portions of the backup image. Moreover, in other examples, a selection may be made as to how to download a full backup image as efficiently as possible, bearing in mind factors such as an existing CPU load on a memory device, the bandwidth between the computing device 100 and a memory device, the distance between the computing device and a memory device, a number of clients of a computing device, characteristics of the available back up image and the like. Thus, resources may be used to efficiently acquire the full backup image from a number of sources.

FIG. 6 is an example of a computing device 600 comprising a BIOS 602 and a processor 604. The computing device 600 may provide an example of the computing device 100 described above. The processor 604 may provide an example of the processor 102 described above. In this example, the BIOS 602 may, for example in response to a user input, a device management instruction or some other trigger, initiate a system recovery operation. Once such an operation is initiated, the BIOS 602 issues a first request for a backup image to devices connected to a same LAN (e.g. LAN 104) as the computing device 600. When a suitable backup image is identified in response to the first request, the computing device 600 accesses the identified backup image via the LAN. For example, this may be received in a reply from a memory device, or host apparatus thereof, as described above. When a suitable backup image is not identified in response to the first request, the computing device 600 issues a second request for a backup image via a WAN (for example, the WAN 112). In examples, the computing device 600 may act as the computing device 100 described in relation to any or any combination of FIGS. 1, 2, 3 and 5.

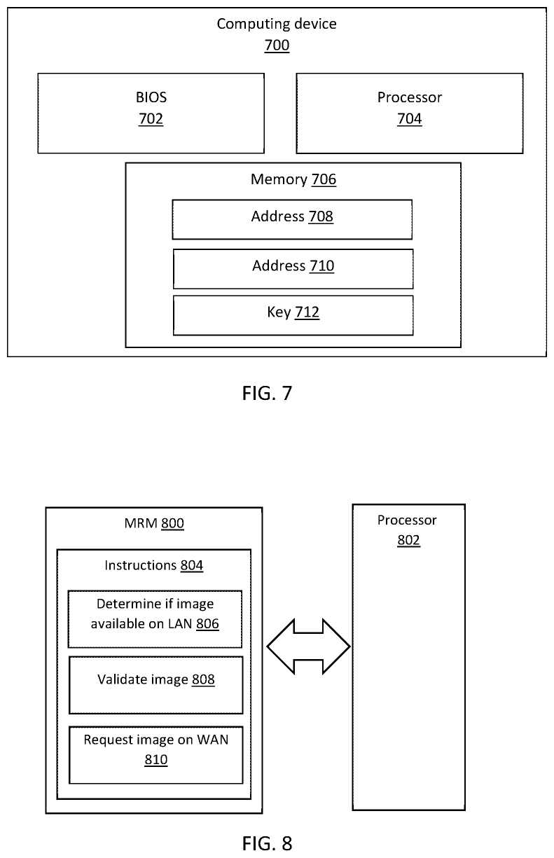

FIG. 7 is another example of a computing device 700, in this example comprising a BIOS 702, a processor 704, and a memory 706. The BIOS 702 and the processor 704 provide the functions described for the BIOS 602 and processor 604 of FIG. 6. Moreover, the memory 706 stores a first address 708 indicative of at least one candidate location of a backup image on a memory device connected to a LAN to which the computing device 700 is connected and a second address 710 indicative of a location of a backup image on a memory device accessible via a WAN. For example, the addresses 708, 710 may comprise URLs, IP addresses or the like. Such information may be stored in a DHCP record, for example. In some examples, at least one of a LAN address and WAN address may be stored for more than one backup image. For example, locations may be stored for one or both of a recovery agent image and an OS backup image. In some examples, multiple locations may be stored for a given backup image. In some examples, this allows a selection of a location from which to acquire the backup image, and it may further allow a single image to be acquired from more than one location as described in relation to FIG. 5 above.

In addition, in this example, the memory 706 stores at least one cryptographic key 712 for use in authenticating an identified backup image. The cryptographic key(s) 712 may comprise a public key which can be used to check a digital signature of at least one of a backup image (e.g. at least one of the recovery agent image and the OS backup image) and a device providing that image.

Any or any combination of the addresses 708, 710 and the cryptographic key 712 may comprise configuration information of the computing device 700 and may be stored as part of an embedded security controller. In some examples, the content of the memory 706 may be managed, for example in a secure manner.

For example, the BIOS 702 may acquire the first address 708 and the key 712 for the recovery agent image from the memory 706. A request for the recovery agent image may be sent to the first address 708. If a recovery agent image is returned, it may be read into a memory (for example, a RAM which may comprise part of the memory 706), and validated using the key 712 and, assuming the recovery agent image is validated, the image may be booted on the computing device 700. In other examples, the signature may be acquired in advance of the image to allow the image to be validated prior to being read into the memory. If no image is returned, or if the validation fails, the BIOS 702 may acquire the second address 710 and access the recovery agent image via the WAN prior to or after validating it with the key 712 and, assuming the recovery agent image is validated, booting it on the computing device 700.

At least one of a LAN and WAN address for an OS backup image may be stored on the memory 706, or may be provided within the recovery agent image. The computing device 700 may first use a LAN address, if available, to attempt to acquire the OS backup image. If an OS backup image is returned, it may be read into a memory (for example, a RAM which may comprise part of the memory 706), and validated using a key (which may be the same key or a different key to that used to validate the recovery agent image). In some examples, the signature may be acquired in advance of the image to allow the image to be validated prior to being read into the memory. Assuming the OS backup image is validated, the image may be booted on the computing device 700. If no image is returned via the LAN, or if the validation fails, the BIOS 702 may acquire the WAN address for the OS backup image and access the OS backup image via the WAN prior to or after validating it with an appropriate key and, assuming the OS backup image is validated, booting the new OS on the computing device 700.

In some examples, the computing device 700 may store the recovery agent image in a memory, for example a non-volatile memory, in which case there may be no retrieval of this image.

In examples, the computing device 700 may act as the computing device 100 described in relation to any or any combination of FIGS. 1, 2, 3 and 5.

FIG. 8 shows an example of a non-transitory machine-readable medium 800 (where the term “non-transitory” does not encompass transitory propagating signals) associated with a processor 802. The machine-readable medium 800 stores instructions 804 readable and executable by the processor 802 to cause the processor 802 to carry out tasks. The instructions 804 comprise instructions 806 to cause the processor 802 to determine whether or not a backup image for reimaging a computing device is available from a memory device on a LAN. For example, this may comprise at least one of a recovery agent image and an OS backup image, as described above. The LAN may be a same LAN as the processor 802 (or a host device thereof) is connected to. The instructions 804 further comprise instructions 808 to cause the processor 802 to, when the backup image appears to be available from the memory device on the LAN, validate an identity of a memory device providing the backup image. In some examples, this may comprise validating that a memory device has an expected identity. In some examples, this may comprise validating that a memory device is managed by an enterprise that manages the computing device. In some examples, this may comprise validating that a memory device is in possession of a digital certificate or other data indicating it is a trusted source of a backup image. The instructions may further cause the processor 802 to acquire the backup image over the LAN, for example when available and validated.

The instructions 804 further comprise instructions 810 to cause the processor 802 to, when the backup image is not available from the memory device on the LAN, request a backup image over a WAN.

In some examples, the instructions 808 to determine whether or not a backup image for reimaging a computing device is available from the memory device on the LAN comprise instructions to determine whether or not a first backup image for reimaging a computing device is available from the memory device on a LAN, the first backup image comprising a recovery agent image. In such examples, the instructions 804 may further comprise instructions to cause the processor 802 to determine, using a location derived from the recovery agent image, a location of an OS backup image. Moreover, in some such examples, the location comprises a location on the LAN, and the instructions 804 may further comprise instructions to cause the processor 802 to determine whether or not the OS backup image for reimaging a computing device is available at the location. In other examples, the location of an OS backup image may be stored in a memory (e.g. a non-volatile memory) of the computing device.

In some examples, the instructions 804 further comprise instructions to cause the processor 802 to, when the OS backup image appears to be available from the memory device on the LAN, validate an identity of a memory device providing the backup image and when the OS backup image is not available from the memory device on the LAN, request an OS backup image over a WAN. The instructions may further cause the processor 802 to acquire the OS backup image (for example, when available and validated) over the LAN.

In some examples, the instructions 804 may further comprise instructions to cause the processor 802 to access at least one location indicative of a possible location of a backup image from a memory of the computing device.

In some examples, the instructions 804 may further comprise instructions to cause the processor 802 to validate a backup image received in response to a request. For example, the instructions 804 may further comprise instructions to cause the processor 802 to access a cryptographic key, and use the key to validate a signature of the backup image.

In examples, the instructions 804 may cause the processor 802 to act as a processor of the computing device 100, the computing device 600 or the computing device 700 described above.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and block diagrams, as well as combinations of the blocks in the flow charts and block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing device(s), so that the computer or other programmable data processing device(s) perform a series of operations to produce computer-implemented processing, thus the instructions executed on the computer or other programmable devices realize functions specified by block(s) in the flow charts and block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing device comprising:
a processor to, in a reimaging operation of the computing device:
determine if a backup image to be used in the reimaging operation is available from a memory device connected to a local area network of the computing device;
when the backup image is available from the memory device, acquire the backup image over the local area network; and
when the backup image is not available from the memory device, determine if a backup image is available from a wide area network of the computing device.

2. The computing device of claim 1, wherein determining if the backup image to be used in the reimaging operation is available from a memory device connected to a local area network of the computing device comprises broadcasting a request for the backup image on the local area network.

3. The computing device of claim 1, wherein the computing device comprises a non-volatile memory, and determining if the backup image to be used in the reimaging operation is available from a memory device connected to a local area network of the computing device comprises transmitting the request to a local area network address stored in the non-volatile memory.

4. The computing device of claim 1, wherein determining if an image is to be used in the reimaging operation is available from a memory device connected to a local area network of the computing device comprises causing the memory device to acquire the image.

5. The computing device of claim 1, wherein determining if an image is to be used in the reimaging operation comprises validating a memory device connected to the local area network which responds to a request indicating that an image is stored thereon.

6. The computing device of claim 1, wherein determining if the backup image to be used in the reimaging operation is available from a memory device connected to a local area network of the computing device comprises sending the request to a print apparatus on the local area network.

7. The computing device of claim 1, wherein determining if a backup image to be used in the reimaging operation is available from a memory device connected to a local area network of the computing device comprises determining that the backup image is available from a plurality of memory devices; and
when the backup image is available from the plurality of memory devices, acquire portions of the backup image from different memory devices.

8. A computing device comprising:
a BIOS; and
a processor to:
when the BIOS initiates a system recovery operation, issue a first request for a backup image to a memory device connected to a same local area network as the computing device;
when a suitable backup image is identified in response to the first request, access the identified backup image via the local area network; and
when a suitable backup image is not identified in response to the first request, issue a second request for a backup image via a wide area network.

9. A computing device according to claim 8 wherein the computing device further comprises a memory, the memory storing:
a first address indicative of a candidate location of a backup image on a memory device connected to the local area network; and
a second address indicative of a location of a backup image on a memory device accessible via the wide area network.

10. A computing device according to claim 8, wherein the computing device further comprises a memory, the memory storing a cryptographic key for use in authenticating at least one of an identified backup image and a memory device providing the backup image.

11. A non-transitory machine-readable medium storing instructions readable and executable by a processor to:
determine whether or not a backup image for reimaging a computing device is available from a memory device of a local area network;
when the backup image appears to be available from the memory device on the local area network, validate an identity of the memory device providing the backup image; and
when the backup image is not available from the memory device on the local area network, request a backup image over a wide area network.

12. A non-transitory machine-readable medium according to claim 11 wherein the instructions to determine whether or not a backup image for reimaging a computing device is available from the memory device on the local area network comprise instructions to determine whether or not a first backup image for reimaging a computing device is available from the memory device on a local area network, the first backup image comprising a recovery agent image;
the medium further storing instructions readable and executable by a processor to:
determine, using a location derived from the recovery agent image, a location of an Operating System (OS) backup image.

13. A non-transitory machine-readable medium according to claim 12, wherein the location comprises a location on the local area network, wherein the machine-readable medium further stores instructions readable and executable by a processor to:
determine whether or not the OS backup image for reimaging a computing device is available at the location;
when the OS backup image appears to be available from the memory device on the local area network, validate an identity of a memory device providing the backup image; and
when the OS backup image is not available from the memory device on the local area network, request an OS backup image over a wide area network.

14. A non-transitory machine-readable medium according to claim 11 further storing instructions readable and executable by a processor to:
access at least one location indicative of a possible location of a backup image from a memory of the computing device.

15. A non-transitory machine-readable medium according to claim 11 further storing instructions readable and executable by a processor to:
validate a backup image received in response to a request.
